(19) United States
(12) Patent Application Publication
(10) Pub. No.: US 2004/0221128 A1
(43) Pub. Date: Nov. 4, 2004

(54) Virtual to physical memory mapping in network interfaces

(75) Inventors: Jon Beecroft, Bristol (GB); David Hewson, Bristol (GB); Moray McLaren, Bristol (GB)

Correspondence Address: VOLPE AND KOENIG, P.C., UNITED PLAZA, SUITE 1600, 30 SOUTH 17TH STREET, PHILADELPHIA, PA, 19103, US

(73) Assignee: Quadrics Limited, Bristol (GB)

(21) Appl. No.: 10/712,218

(22) Filed: Nov. 13, 2003

(30) Foreign Application Priority Data
Nov. 15, 2002 (GB) 0226739.1

(51) Int. Cl. G06F 12/08

(52) U.S. Cl. 711/203

(57) ABSTRACT

A computer network (1) comprises:- a plurality of processing nodes, at least two of which each having respective addressable memories and respective network interfaces (2); and a switching network (3) which operatively connects the plurality of processing nodes together, each network interface (2) including a memory management unit (8a) having associated with it a memory in which is stored (a) at least one mapping table for mapping 64 bit virtual addresses to the physical addresses of the addressable memory of the respective processing node; and (b) instructions for applying a compression algorithm to said virtual addresses, the at least one mapping table comprising a plurality of virtual addresses and their associated physical addresses ordered with respect to compressed versions of the 64 bit virtual addresses. The network interface (2) provides visibility across the network of areas of the memory of individual processing nodes in a way which supports full scalability of the network.

The present invention relates to memory management systems for translating virtual addresses into physical addresses in a computer system. Particularly, but not exclusively, the present invention relates to the mapping of virtual addresses to physical addresses in large-scale parallel processing systems.

With the increased demand for scalable system-area networks for cluster supercomputers, web-server farms, and network attached storage, the interconnection network and it's associated software libraries and hardware have become critical components in achieving high performance in modem computer systems. Key players in high-speed interconnects include Gigabit Ethernet (GigE)™, GigaNet™, SCI™, Myrinet™ and GSN™. These interconnect solutions differ from one another with respect to their architecture, programmability, scalability, performance, and ease of integration into large-scale systems.

Modem computer systems typically provide some form of virtual memory environment. The use of virtual memory has advantages in simplifying software processing, especially when running large programs. To the software, the virtual memory appears to be on volatile memory such as RAM but can actually relate to memory such as hard disk storage. Thus the virtual addresses used by the central processing unit (CPU) of the computer system can be mapped to different physical locations within the computer system, i.e. on the hard disk, creating the illusion that there is more RAM than is actually physically available.

In a virtual memory environment of the type described above, software instructions access memory using virtual addresses, which may be allocated, for example, by the CPU. The memory management unit (MMU) of the computer system then translates these virtual addresses into physical addresses. MMUs are generally operatively connected between the CPU and the memory of a computer system.

Memory management has grown in popularity to the extent that the design of the MMU has become critical to the performance of modern computer systems, with memory bandwidth being the main limiting factor on system performance.

The MMU automatically translates a virtual address into a physical address. Typically, the virtual memory and the physical memory are both divided into fixed sized segments called pages, with each virtual address being a combination of a virtual page address and a page offset. Similarly, each physical address is a combination of a physical page address and a page offset. Whenever the CPU of the computer system wants to access memory, for example, to store data, it generates a virtual address and sends it to the MMU, which translates it to a physical address, enabling the memory access to be carried out.

An example of a system for translating virtual addresses into physical addresses is described in European patent application publication number EP1035475. This document describes a memory management unit, whereby during an execution or a fetch of a program instruction by a CPU, the MMU receives a virtual address. The MMU then directly converts the virtual address to a physical address by attaching one of two alternative address codes to the virtual address. This is only effective for smaller sized virtual addresses, for example, 16 bit addresses.

In order to more efficiently map virtual addresses to physical addresses, MMUs are also known which maintain a set of data structures known as a page table. A page table comprises at least one table cell containing data on an associated physical page address for each virtual address. The page table may also contain information about when each virtual address was last accessed, and security rights information about which system users can read/write to the physical address corresponding to that virtual address. The page table maps the virtual page addresses to associated physical page address s.

Translation of a virtual address by the MMU is generally accomplished by using the page table directly, i.e. by looking down the cells sequentially, until the physical page address associated with the virtual address being translated, is found. Once the associated physical page address is found and has been read from the table, the page offset portion of the virtual address is then attached to the physical page address to form the complete physical address, which then enables the relevant memory access.

An example of a memory management system which uses a page table to implement virtual address translation, is described in German patent number, DE 4,305,860. This document describes a memory management system which incorporates a memory management unit that supports a page table that is divided into sub tables with multiple stages arranged on different levels.

Further still, the Elan 3 (trade mark of Quadrics Limited) network interface incorporates a memory management unit, which translates virtual addresses into physical addresses using multi-stage page tables. A small datapath and state machine of the network interface performs “table walks” in order to translate the 32 bit virtual addresses into 64 bit physical addresses.

Further, United States patent serial number, U.S. Pat. No. 5,956,756 describes the use of a page table in a memory management system to convert virtual addresses into physical addresses, which supports different page sizes. In this system, it is assumed that the size of the page of memory to which an individual virtual address refers is unknown. To translate a virtual address into a physical address, a series of tests are performed on the virtual address with each test assuming a different page size for the virtual address to be translated. During the series of tests, a pointer into a translation storage buffer is calculated, and the pointer points to a candidate translation table entry having a candidate tag and candidate data. The candidate tag identifies a particular virtual address and the candidate data identifies a physical address associated to the identified virtual address. A virtual address target tag is also calculated which is different for each test page size. The target tag and the candidate tag are then compared. If they match, then the candidate data is provided as the physical address translation corresponding to the virtual address.

The use of a page table provides a useful way of translating virtual addresses into physical addresses in a computer system. The size of a typical virtual memory page may be, for example, 8 K bytes, or 4 M bytes, with the size of a virtual address typically being, for example, 32 bits. Since with conventional systems the page table cells are addressed sequentially, the page table is required to have a capacity large enough to accommodate every possible permutation of the virtual address. For example, of a 32 bit virtual address 19 bits would normally be required to be translated. However, added to this is the context, which may be anything between 8 and 16 bits wide and must be added to that portion of the virtual address to be translated.

Attempts have been made to overcome the problem of memory usage in address translation. For example, the page table can be modified such that there are no empty cells. However, this results in a much more complicated virtual address translation and can increase latency. In conventional computer systems, consumption of available memory in the address translation process is reduced by restricting the number of bits used in virtual addresses so that a smaller page table may be employed. This in turn, however, restricts the amount of memory that can be addressed by the computer system.

United States patent serial number U.S. Pat. No. 6,195,674 describes a graphics processor for the creation of graphical images to be printed or displayed. The graphics processor incorporates a co-processor and an image accelerator card, which assists in the speeding up of graphical operations. The image accelerator card includes an interface controller, and the co-processor operates in a shared memory manner with a host CPU. That is to say the co-processor operates using the physical memory of the host processor and is able to interrogate the host processor's virtual memory table, so as to translate instruction addresses into corresponding physical addresses in the host processor's memory. The host's main memory includes a hash table, which contains page table entries consisting of physical addresses each of which is associated with a 20 bit code that is a compression of a conventional 32 bit virtual address but is only capable of supporting one virtual memory page size.

The present invention seeks to provide an improved network interface to facilitate memory management in a processing node forming part of a computer network and an improved method of translating virtual addresses into physical addresses in a computer network. A representative environment for the present invention includes but is not limited to a large-scale parallel processing network.

In accordance with a first aspect of the present invention there is provided a computer network comprising:—a plurality of processing nodes, at least two of which each having respective addressable memories and respective network interfaces; and a switch network which operatively connects the plurality of processing nodes together, each network interface including a memory management unit having associated with it a memory in which is stored: (a) at least one mapping table for mapping 64 bit virtual addresses to the physical addresses of the addressable memory of the respective processing node, and (b) instructions for applying a compression algorithm to said virtual addresses, the at least one mapping table comprising a plurality of virtual addresses and their associated physical addresses ordered with respect to compressed versions of the 64 bit virtual addresses.

In accordance with a second aspect of the present invention there is provided a method of reading or writing to a memory area of the addressable memory of a processor in a computer network, comprising the steps of: inputting a memory access command to a network interface associated with the processor, the network interface having a memory management unit in which is stored at least one mapping table mapping 64 bit virtual addresses to the physical addresses of the addressable memory of the processor, the contents of the mapping table being ordered with respect to compressed versions of the 64 bit virtual addresses; compressing the virtual address of the memory access for which a corresponding physical address is required; locating a mapping table entry in the mapping table of the network interface on the basis of the compressed version of the virtual address; comparing the virtual address of the located mapping table entry with the virtual address for which a corresponding physical address is required; where the comparison confirms the virtual address of the located mapping table entry matches the virtual address of the memory access command, reading one or more physical addresses associated with the matched virtual address; and the network interface actioning the memory access command.

In accordance with a third aspect of the present invention there is provided a network interface adapted to operatively connect to a network of processing nodes a respective processing node having associated with it an addressable memory, the network interface including a memory management unit having associated with it a memory in which is stored (a) at least one mapping table for mapping 64 bit virtual addresses to the physical addresses of the addressable memory of the respective processing node; and (b) instructions for applying a compression algorithm to said virtual addresses, the at least one mapping table comprising a plurality of virtual addresses and their associated physical addresses ordered with respect to compressed versions of the 64 bit virtual addresses.

Thus, unlike conventional network systems the present invention provides visibility across the network of areas of the memory of individual processing nodes in a way which supports full scalability of the network. Furthermore the present invention removes the software layers commonly associated with other known network environments through the implementation of a memory management unit in the network interface. Most importantly the present invention supports 64 bit virtual addresses and preferably multiple page sizes in a way which minimises the memory requirements of the page tables through the use of hash tables.

In a first preferred embodiment, the memory management unit of the network interface includes at least one, more preferably two, two translation lookaside buffers. The translation lookaside buffers are searched before the mapping table is used to translate the 64 bit virtual addresses into the physical addresses. It is preferred that the physical address associated with the virtual address being searched is read from the translation lookaside buffers. The translation lookaside buffers are used to translate regularly used virtual addresses into physical addresses.

It is also preferred that the network interface further includes a thread processor and a microcode processor, wherein one translation lookaside buffer of the memory management unit is dedicated to the thread processor and the other translation lookaside buffer is dedicated to the microcode processor of the network interface.

It is further preferred that a chain pointer is used to point to mapping table entries, in the case where two different virtual addresses are compressed to the same compressed virtual address.

An embodiment of the present invention will now be described, by way of example only, with reference to the accompanying drawings in which:

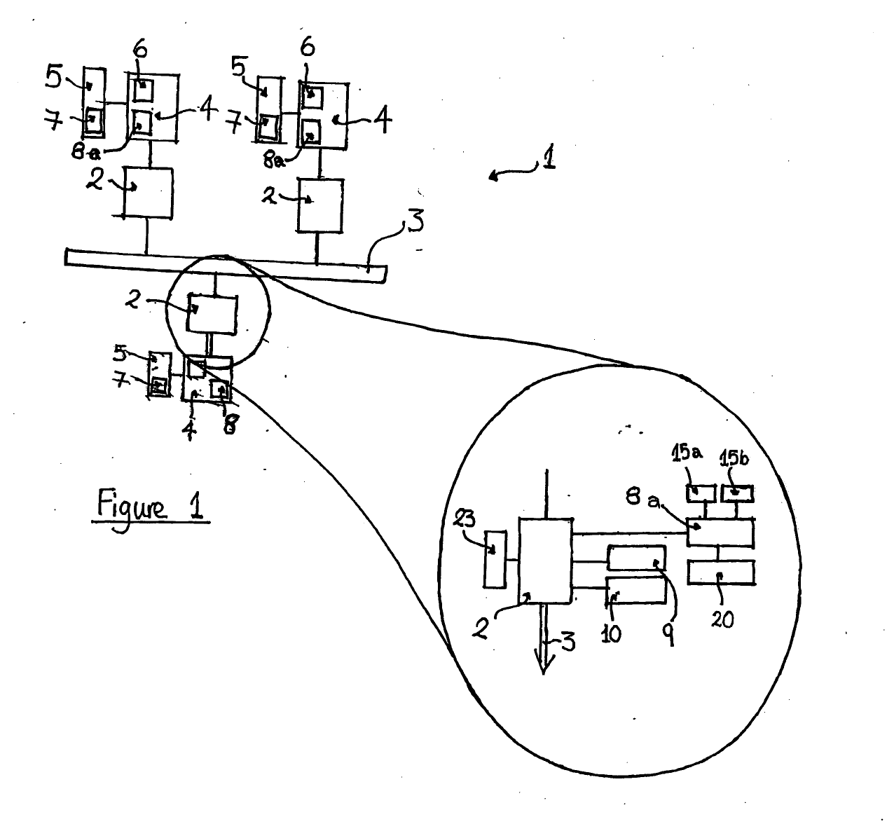

FIG. 1 is a schematic diagram of a computer network in accordance with the present invention with an enlargement of one of the network interfaces:

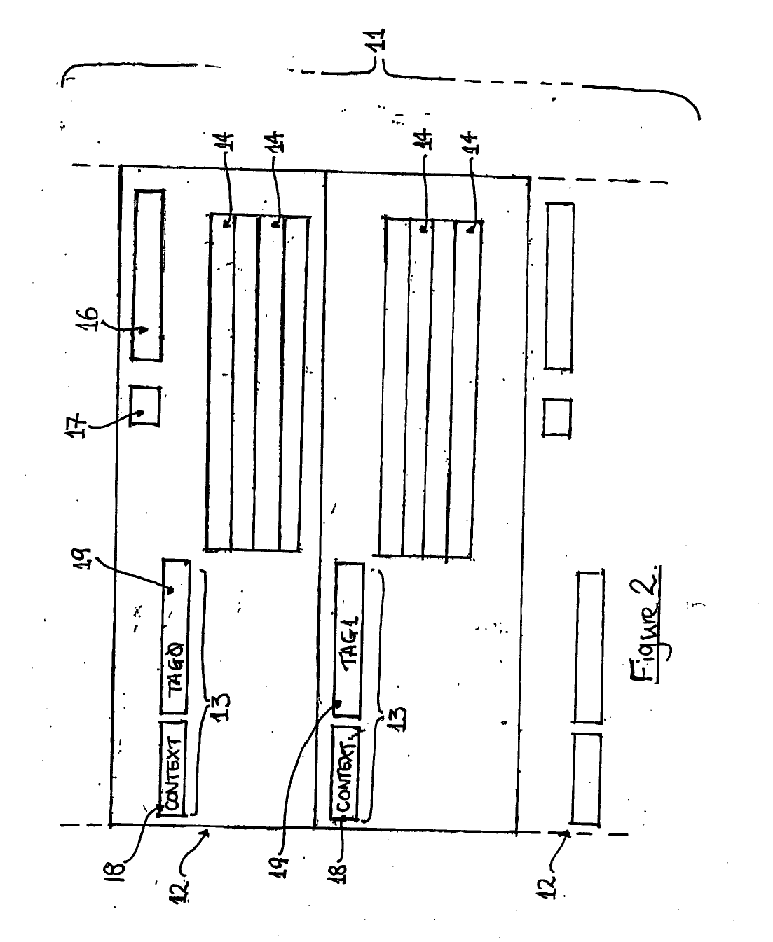

FIG. 2 illustrates a simplified hash table which may be utillised in a mapping method in accordance with the present invention; and

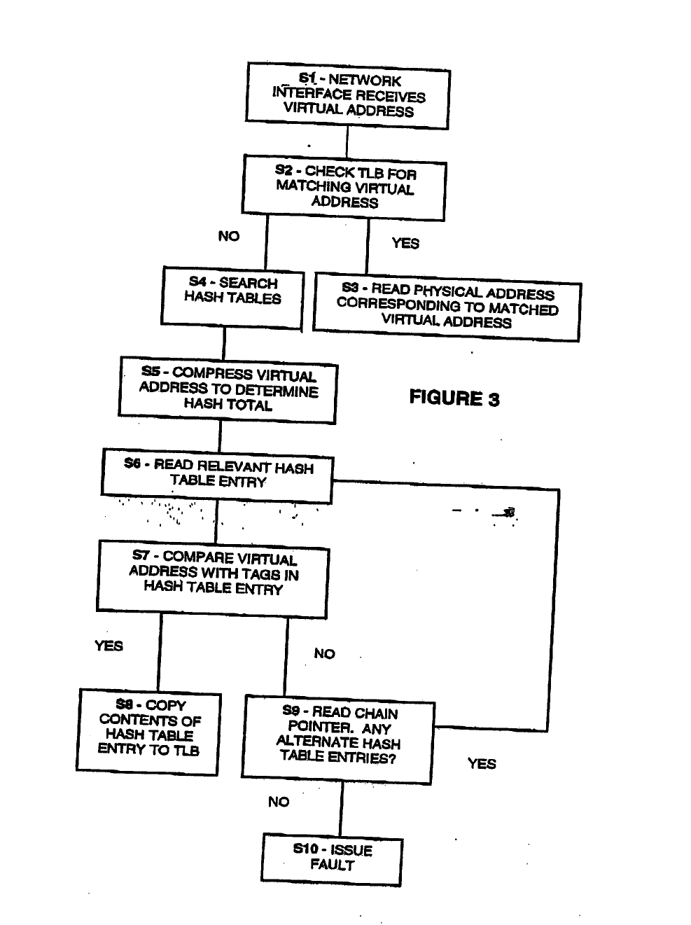

FIG. 3 is a flow chart illustrating the method of translating virtual addresses to physical addresses in accordance with the present invention.

FIG. 1 illustrates a computer network 1 which includes a plurality of separate processing nodes connected across a switching network 3. Each processing node may comprise a processor 4 having it's own cache 6 i.e. volatile memory (fast access) and main memory 5 including non-volatile memory 7 as well as an associated memory management unit (MMU) 8 which contains data on physical memory addresses and their associated virtual memory addresses. Each processing node 4 also has a respective network interface 2 with which it communicates across a data communications bus, The network interface 2 includes it own network interface MMU 8a, a thread processor 9, a microcode processor 10 and its own interface memory 23. The network interface 2 is adapted to store in its own MMU 8aa copy of data stored in its respective processing node's MMU 8 so as to be synchronised with this data which is restricted to areas of memory that are to be made available to other processing nodes in the network i.e. a user process's virtual address space.

The computer network 1 described above is suitable for use in parallel processing systems. Each of the individual processors 4 may be, for example, a server processor such as a Compaq ES45. In a large parallel processing system, for example, forty or more individual processors may be interconnected with each other and with other peripherals such as, but not limited to, printers and scanners.

Each network interface MMU 8ais capable of supporting up to eight different page sizes with up to two page sizes active at any one time with separate hash tables 11 for each active page size for example page sizes of 8k and 4M. As described earlier, in general, a hash table is a data structure consisting of a plurality of data entries each relating to a hash total and the associated physical addresses. The MMU 8atranslates 64 bit virtual addresses in either 31 bit SDRAM physical addresses (local memory on the network interface) or 48 bit PCI physical addresses.

The MMU 8aalso includes two associative memory components called Translation Lookaside Buffers (TLBs) 15. The TLBs 15 are used to assist the MMU Ba in ascertaining whether an address assigned by the MMU 8acorresponds to a physical address already held in the cache 6 of the processor 4 or whether the data contained in the corresponding area of memory must be fetched from the RAM 7 and written into the cache 6.

A first TLB 15aof the MMU 8ais dedicated to the thread processor 9 of the network interface 2 and the second TLB 15bis dedicated to the microcode processor 10 of the network interface 2. The thread processor 9 is a 64 bit Risc processor that aids in the implementation of higher-level messaging libraries without explicit intervention from the processor 4. The microcode processor 10 processes microcode stored on the applications specific integrated circuit (ASIC) of the network interface 2 for speed of memory access (Microcode enables the instruction set of a computer to be expanded without the addition of further hardware components). Both TLBs 15 of the MMU 8aare identical to each other and each one preferably has 16 cells wherein each cell can translate up to four pages of virtual memory to physical memory, resulting in a total mapping of up to 128 pages of virtual memory. The part played by the TLBs 15 in the translating process will be described in greater detail later. In overview, the TLBs 15 are used to translate regularly used virtual addresses into physical addresses, without resorting to the use of the mapping tables 11. This improves the latency of the network.

The MMU 8auses a hashing function, which is an algorithm, to compress the virtual addresses to corresponding hash totals. The hashing function may be keyed, but it is to be understood that any suitable compression algorithm may be used. Each network interface 2 of the network 1 uses the same hashing function to compress the virtual addresses. With the network interface described herein the hashing function is used to compress virtual addresses of 64 bits in size, down to 32 bits in size. Of course, other degrees of compression may be adopted, where appropriate, in order to compress the 64 bit virtual address down to 32 bits, the hashing function retains the first 12 bits of the virtual address in its original form, and compresses the remaining 52 bits down to 20 bits. This results in a compressed 32 bit virtual address code (hash total) Through the use of the hashing function, a page table can be used which contains a reduced number of entries in comparison to the number of entries required if the virtual addresses had not been compressed. It should be noted, however, that the individual entries 12 of the hash table 11 contain uncompressed virtual addresses 13 and their associated physical addresses 14, not the hash total which is only used to identify the relevant entry in the hash table to interrogate.

When virtual addresses are compressed, depending on the nature of the hashing function, collision problems may be encountered i.e. there is a risk that, when different virtual addresses are compressed, they may be compressed to the same 32 bit virtual address code. This is termed a collision. The MMU 8 permits collisions arising from compression of the virtual addresses by generating a chain to an alternate entry for an identical hash total but a different virtual address and this chain can be extended as necessary where more than two virtual addresses are compressed to the same hash total. Thus each entry in the hash table has a chain pointer 16 of for example 25 bits which is set to zero where no collisions exist or the entry is the last in a chain of entries. Furthermore, where a chain has been generated preferably a copy of the entry for the most often accessed virtual address, of the set of virtual addresses having the same hash value, is introduced to the head of the chain and is identified as a copy by means of a copy bit 17. The size of the hash table is set according to the size of the physical memory to be mapped and is programmable at start-up. This allows the size of the hash table to be increased in order to reduce the collision rate.

By compressing the 64 bit virtual address, the size of the mapping table 11 is greatly reduced from having 2⁽⁶⁴⁻¹³⁾ entries to having 2³²+(Number of Alternates) entries. However, the accommodation of alternates requires an additional translating step (described below) which increases the latency of the system. The extent of compression of the virtual addresses is accordingly limited by the number of alternates arising out of the compression procedure adopted; if the virtual address is compressed too much, so many collisions arise that the latency of the system becomes too high. Accordingly, an optimum compression, such as 64 bits to 32 bits, is chosen, which provides sufficient compression to achieve a substantial saving of memory space, whilst not compressing the virtual address so much that the latency of the network is compromised.

As can be seen from FIG. 2, each entry 12 of the hash table 11 includes two virtual addresses 13 each consisting of two data segments, a context data segment 18 and a tag 19. Each tag 19 maps four adjacent pages of virtual memory. Hence, each entry 12 contains eight corresponding physical addresses relating to the two tags 19 Conveniently, the RAM 7 is set up to deliver data in bursts of 64 bytes corresponding to the hash table 11 addresses which are 64 bytes or 8*64 bit words.

In practice, when the network interface 2 receives a virtual memory access for example, the network interface 2 identifies the context (user process) of the memory access and the relevant physical memory address corresponding to the virtual address of the memory access and then retrieves the required data from the memory of its respective processor 4. The interface 2 then identifies where the retrieved data is to be written and determines the appropriate route through the switching network 3 from the route table stored in its memory 23 on the basis of the context of the memory access. The route data is then attached to the front of the data before it is issued to the switching network. The data is routed through the switching network, using the routing data at the front of the data, to the destination processor 4.

In particular with reference to FIG. 3, the interface 2 of the processor 4 receives a virtual address which including data on its context (S1). Before referring to the hash tables 11, the MMU 8achecks the TLBs 15 to search for a physical address to match the virtual address (S2). Use of a TLB 15 in this way increases the speed of translation from virtual address to physical address, because repeated translations providing the same physical address can be performed using the TLB 15 alone, without the need to turn to the hash tables 11 to translate a virtual address. If the virtual address that has been received by the network interface matches a virtual address stored in the TLB 15, the corresponding physical address is read from the TLB 15 (S3)

If no matching virtual address is found using the TLBs 15, the hash tables 11 are searched (54). Where more than one hash table relating to different page sizes are active, it is not known in advance what page size the virtual address relates to and so it is also not known which of the two hash tables to search first. First one hash table then the other is searched. The hash table for the smaller page translation is preferably carried out before the larger page translation.

To find a matching virtual address in the hash table 11, the hash total corresponding to a 32 bit compressed version of the virtual address is determined (S5) and the entry in the hash table relating to that hash total is read (S6). The virtual address is then compared with the each of the two tags 19 of the relevant hash table entry (S7). If one of the tags 19 matches the virtual address, then a small datapath and state machine 20 in the MMU 8a is used to transfer the full 64 bit virtual address and the associated physical addresses to the TLB 15 (S8). The virtual address and its associated physical address can then read from the TLB 15 when the virtual memory access is repeated (S3). Repetition of the virtual memory access arises when there has been no response to the initial memory access.

As discussed earlier there exists the possibility that in the hashing process two different 64 bit virtual addresses are compressed down to the same compressed virtual address code. This means there is a risk that when the entry in the hash table for a particular hash total is located and the tags compared against the full virtual address, no match may be found. Of course, when the required virtual address is in the hash table entry at the head of the chain (which is chosen to be the virtual address most often accessed), a match will be found during the initial comparison (S7). However, if the required virtual address is not in the entry at the head of the chain, no match will be found and the MMU 8achecks the chain pointer 16 of the hash table entry to determine whether alternates exist (S9). As described earlier the chain pointer 16 points to the next link in the chain which is an alternate entry for the same hash total. The alternate entry is then read (S6) and the comparison and matching step is again performed (S7). These steps are repeated for second and subsequent links in the chain until either a 64 bit virtual address match is found and transferred to the TLB 15 (S8), or a null chain pointer is reached. If no match is found and the chain pointer 16 is zero, then the MMU 8 issues a fault instruction (S10) and the small datapath and state machine 20 saves the address, context and fault type into a trap area of cache 6.

The tags 19 and chain pointers 16 are in the first two 64 byte data values issued to the cache 6 when a hash table entry is accessed. This means that the match decision can occur early, allowing a possible memory access for the next block of 64 byte data values to be scheduled before all of the data of the first access has been received.

The hash tables 11 of the MMU 8 are formulated by the state machine 20 and are controlled by three registers, namely the hash table base address register (of which there is one for every hash table), the fault base address register, and the MMU control register. These registers define the position, size and type of each hash table 11, and its index method. Addresses for indexing the hash tables 11 are formed by OR, AND and shift operations.

The 32 bit hash table base address register forms a full hashed virtual address from what is termed the initial hashed virtual address. The initial hashed virtual address is formed from the virtual address and context. The context determines which remote processes can access the address space via the network and where those processes reside. Contexts tend to be generated close to each other so it is important that a low order context change produces a significant change in the initial hashed virtual address. The 32 bit fault base address register acts as a pointer to the region in memory where information about the fault, for example a failed translation, is stored. The 32 bit MMU control register is used to control and set up the rest of the MMU 8a, and is used in conjunction with the state machine 20 to formulate the hash tables 11. It also enables the cache 6 and clears RAM 7 errors. Its value is undefined after reset

As can be seen from the above, the network interface described above includes a memory management function for translating virtual addresses into physical addresses, which provides advantages not previously available to computer systems. In particular significant reductions in the latency of the network can be achieved as memory access is facilitated, but remains secure, without intervention by the operating system. The present invention is particularly suited to implementation in areas such as weather prediction, aerospace design and gas and oil exploration where high performance computing technology is required to solve the complex computations employed. Moreover, by compressing the virtual addresses describing the virtual address space, the memory space taken up by the address translation processes can be significantly reduced whilst still supporting the adoption of 64 bit virtual addresses whereby the latency of the computer network can be kept to a minimum.

The present invention is not limited to the particular features of the network interface described above or to the features of the computer network as described. Elements of the network interface may be omitted or altered, and the scope of the invention is to be understood from the appended claims. It is noted in passing that an alternative application of the network interface is in large communications switching systems.

1. A computer network comprising:- a plurality of processing nodes, at least two of which each having respective addressable memories and respective network interfaces; and a switching network which operatively connects the plurality of processing nodes together, each network interface including a memory management unit having associated with it a memory in which is stored (a) at least one mapping table for mapping 64 bit virtual addresses to the physical addresses of the addressable memory of the respective processing node; and (b) instructions for applying a compression algorithm to said virtual addresses, the at least one mapping table comprising a plurality of virtual addresses and their associated physical addresses ordered with respect to compressed versions of the 64 bit virtual addresses.

2. A computer network as claimed in claim 1, wherein the memory management unit of the network interface includes two translation lookaside buffers.

3. A computer network as claimed in claim 2, further comprising a thread processor and a microcode processor, wherein one translation lookaside buffer of the memory management unit is dedicated to the thread processor and the other translation lookaside buffer is dedicated to the microcode processor of the network interface.

4. A computer network as claimed in claim 1, wherein each entry of the mapping table of the memory management unit includes two tags representative of two virtual addresses.

5. A computer network as claimed in claim 4, wherein each tag is associated with four physical memory addresses.

6. A computer network as claimed in claim 1, wherein each entry of the mapping table further includes a chain pointer, which is used to identify alternate entries in the mapping table for different virtual addresses having identical compressed virtual addresses.

7. A method of reading or writing to a memory area of the addressable memory of a processor in a computer network, comprising the steps of:
inputting a memory access command to a network interface associated with the processor, the network interface having a memory management unit in which is stored at least one mapping table mapping 64 bit virtual addresses to the physical addresses of the addressable memory of the processor, the contents of the mapping table being ordered with respect to compressed versions of the 64 bit virtual addresses;
compressing the virtual address of the memory access for which a corresponding physical address is required;
locating a mapping table entry in the mapping table of the network interface on the basis of the compressed version of the virtual address;
comparing the virtual address of the located mapping table entry with the virtual address for which a corresponding physical address is required;
where the comparison confirms the virtual address of the located mapping table entry matches the virtual address of the memory access command, reading one or more physical addresses associated with the matched virtual address; and
the network interface actioning the memory access command.

8. A method as claimed in claim 7, including the additional step of before compressing the virtual address, comparing the 64 bit virtual address for which a corresponding physical address is required with 64 bit virtual addresses stored in one or more lookaside buffers and where a match is found, reading the one or more physical addresses associated with the matched virtual address stored in the lookaside buffer.

9. A method as claimed in claim 7, wherein the memory management unit of the network interface supports two separate page sizes with separate mapping tables for each page size and wherein the content of each mapping table is search in turn to locate an entry relevant to the virtual address of the memory access.

10. A network interface adapted to operatively connect to a network of processing nodes a respective processing node having an associated addressable memory, the network interface including a memory management unit having associated with it a memory in which is stored the following: - (a) at least one mapping table for mapping 64 bit virtual addresses to the physical addresses of the addressable memory of the respective processing node; and (b) instructions for applying a compression algorithm to said virtual addresses, the at least one mapping table comprising a plurality of virtual addresses and their associated physical addresses ordered with respect to compressed versions of the 64 bit virtual addresses.

11. A network interface as claimed in claim 10, wherein the memory management unit of the network interface includes two translation lookaside buffers.

12. A network interface as claimed in claim 11, further comprising a thread processor and a microcode processor, wherein one translation lookaside buffer of the memory management unit is dedicated to the thread processor and the other translation lookaside buffer is dedicated to the microcode processor of the network interface.

13. A network interface as claimed in claim 10, wherein each entry of the mapping table of the memory management unit includes two tags representative of two virtual addresses.

14. A network interface as claimed in claim 13, wherein each tag is associated with four physical memory addresses.

15. A network interface as claimed in claim 10, wherein each entry of the mapping table further comprises a chain pointer, which is used to identify alternate entries in the mapping table for different virtual addresses having identical compressed virtual addresses.
